(19) United States
(12) Patent Application Publication
(10) Pub. No.: US 2014/0214505 A1
(43) Pub. Date: Jul. 31, 2014

(54) RATES OF RECYCLING AND OTHER ENVIRONMENTALLY BENEFICIAL ACTIONS

(71) Applicants: Eva Louise Shuster-Arechiga, Fresno, CA (US); Gary Stephen Shuster, Fresno, CA (US)

(72) Inventors: Eva Louise Shuster-Arechiga, Fresno, CA (US); Gary Stephen Shuster, Fresno, CA (US)

(21) Appl. No.: 13/754,877

(22) Filed: Jan. 30, 2013

(51) Int. Cl. G06Q 30/02; G06Q 10/00

(52) U.S. Cl. CPC G06Q 30/0208; G06Q 10/30
USPC 705/14.11; 705/308

(57) ABSTRACT

A system, method, and apparatus is provided that identifies recycling or other environmentally beneficial activities and provides the user with easily understood data about the environmental impact of such activities. The activities are measured and may be used to provide incentives for recycling, such as credits for online applications, positions on a leaderboard, identification of recycling achievements on social networking sites, and financial and other rewards.

### BACKGROUND

1. Field

The present disclosure relates to measurement of environmental impact of energy use reduction and recycling activities and incentivization of such activities.

2. Description of Related Art

Recycling activities, such as recycling newspapers, cans, and bottles, have been widely encouraged and desired for at least several decades. However, there is no easy modality by which people may receive immediate positive feedback for recycling in the form of data about the impact of individual or other acts of recycling.

While aggregate data may be available, in order to determine the positive impact of recycling, people are forced to seek out such information on their own. For people not used to recycling, not apprised of the data, or for people (such as children) unable to easily obtain such data, it is difficult to understand and appreciate the actual impact of each act of recycling.

Similarly, other environmentally beneficial acts, such as reducing power consumption by turning off a light switch, are not easily or immediately measurable in terms of the actual environmental benefit.

### SUMMARY

The present disclosure presents a method, a system, and an apparatus for improving rates of recycling and other environmentally beneficial actions.

The environmental benefits of any given act of recycling are typically quite difficult for individuals to measure (for the purposes of this disclosure, we use the term recycling, but define it to include other actions, including those that are environmentally beneficial, such as saving energy). For example, the act of putting a plastic soda bottle in a recycling bin instead of the trash can is generally understood to be environmentally beneficial, but most people would be unable to identify the ways in which it is beneficial and even the order of magnitude of the benefits it provides. Recycling is typically discussed in terms of billions of pounds of items, terawatts of energy saved, and other amounts so large as to be functionally beyond easy application to any given action by a single person. While limited resources exist to translate manually inputted data from one format to another, such as World Wide Web-based “recycling calculators”, existing technology provides no easy method to encourage recycling by providing immediate incentives and positive reinforcement through an evaluation of the impact of any given act or acts of recycling. The difference between “recycling that can is good” and “recycling that can saves as much energy as turning off two 100 watt bulbs for an hour” may well be the difference between a person thinking that a single can will not make a material difference and that same person recycling the can.

A further aspect disclosed herein is the incorporation of competitive, social networking, and gaming elements. Other than self-reported recycling or environmentally beneficial deeds, existing technology provides no mechanism for harnessing the power of gaming, social networking, and the human competitive instinct to improve the rate of environmentally beneficial acts. While it is common for people to compete on YouTube® for the most views of their video, to compete on Facebook® for the greatest number of likes, to compete on Twitter® for the greatest number of retweets, to compete with Nike+® for the greatest fitness gains, or to compete in other forums for tangible and intangible rewards, extent technology is incapable of harnessing these and similar mechanisms to improve the environment. Merely gathering and making available such data in the environmental sphere is capable of altering behavior, as demonstrated by the measurement of metered consumable resources (i.e. electricity and gas). Various energy providers have made energy consumption data available to consumers, and consumers have used such data to alter consumption patterns. However, extent technology is incapable of extending such automated measurement capabilities outside of fungible consumable energy or water resources that have traditionally been metered. Indeed, environmental conservation of even such traditionally metered resources can be improved by aspects described herein.

These teachings provide an easy, and optionally passive, method to monitor, quantify, and report environmentally beneficial actions. While the aspects disclosed herein encompass more aspects and elements, as described in the following sections, we describe some aspects in the example given in this section.

In one aspect, one or more target resources or resource groups are identified. For this example, we identify (a) aluminum cans (“cans”), (b) glass bottles (“glass”), and (c) recyclable paper (“paper”). A receptacle 100 is created capable of receiving cans, glass, and paper (or, in cases where avoiding intermixing of one or more target resources is desirable, more than one receptacle may be utilized so that one or more of the receptacles may be limited in the kinds of resources they may receive). In one implementation, the receptacle is off or in a reduced power state until actuated by a user.

The receptacle 100 has an opening 110 where recyclable materials can be placed. In one implementation, a scanner or camera 210 and/or a weight scale 230 may identify the materials by computerized object recognition, by reading a bar code, Quick Response (QR) code, or similar code, by performing Optical Character Recognition (OCR) on text located on the object, by calculating the weight of the object (optionally in the case of multiple objects, determining whether the objects are similar and/or the individual weight of the objects), or a combination thereof. Additional data may be received via an attached input device 240, a card reader 270, and/or via computing devices such as a tablet 170, a smart phone 180, a laptop 190, or a desktop 200. Such computing devices may be connected via a wide area network 150 or via Bluetooth, near field computing, or similar local communications method 220. Data may be processed using a local computing device 250. Similarly, data may be compared to a database on a server 160 and/or sent to a server 160 for further processing.

The person placing the object in the receptacle 100 may be identified by an exchange of data between a computing device such as a smart phone 180 and the receptacle. Such identification may incorporate GPS, wifi-geolocation, signal triangulation, and/or other geolocation mechanisms to verify that the device is proximate to the receptacle. The person may also be identified by reading data sent passively by the person or devices associated with the person, such as radio signals, RFID signals, voice print, facial recognition, fingerprint, retina print, finger prints on the item being placed in the receptacle, heat signature, identifying marks on the body, or other methods. In one implementation, instead of, or in addition to, identification of the person placing the item in the receptacle, data on the item being placed in the receptacle may be used to identify a person who is not necessarily the person placing the item in the receptacle. Taking one example, a marker placed on the item (such as a code printed on cans or a mailing label on a magazine) may be used to identify a person or entity who at one point obtained possession of the item now being placed in the receptacle. Such person or entity may be credited with part of, or the entire recycling act. In another aspect, a given receptacle 100 may be associated with a particular person, entity, and/or account so that all items placed therein are assumed to be placed there by such person or entity. The device and/or manual means may be given the capability to override such assumption.

In one implementation, once the item (or items) placed in the receptacle have has been identified, information about the environmental impact of recycling such item (or items) may be provided to the person placing the item in the receptacle by displaying such data on a local display 130 and/or on a portable computing device such as a smart phone 180.

In one implementation, once the item and one or more persons to credit for recycling have been identified, such data may be transferred via a network connection 140 (or, in some cases, via a local connection 220) to another device. Such data may be transferred to a server 160 which server may house or update social networking data, communications systems (such as Twitter®), goal-tracking systems, or other network services. Such data would then be utilized to update an environmental scoring, ranking, or information system. For example, a user's Facebook® page may automatically be updated to show how many tons of carbon dioxide the user has prevented from being emitted during the past 30 days, or a user's Twitter® feed may automatically be updated every time the user recycles an aggregate of 100 pounds of material since the last update. Contests and/or financial incentives may also be tied to such data. The results of such updates may be shared (and/or their sharing may be approved) via computing devices such as a tablet 170, a smart phone 180, a laptop 190, or a desktop 200.

Where network connectivity is not available and/or where an additional or different type of feedback is desired, the data may be provided to the user via a printer 260 and/or a magnetic or other type of card reading/updating unit 270 which printer and/or unit may be attached to the receptacle 100 or may be stand-alone units.

Where the data is provided by a metering system, such as a measurement of electrical usage, such data may also be automatically (or manually) transferred to the system, associated with an account and/or person and/or entity, and the social networking, rewards, competitive, and other elements of the system applied to such data.

A more complete understanding of the method, system and apparatus for improving rates of recycling and other environmentally beneficial acts will be afforded to those skilled in the art, as well as a realization of additional advantages and objects thereof, by a consideration of the following detailed description of the preferred embodiment. Reference will be made to the appended sheets of drawings which will first be described briefly.

### BRIEF DESCRIPTION OF THE DRAWINGS

FIG. 1 is a drawing showing an exemplary implementation of one or more aspects of the systems, methods and apparatuses described herein. The elements in FIG. 1 identified by number are further described below. It should be noted that each item is intended as exemplary of a class of similar items and the drawing and description are not intended as limiting the item to the specific brand, design, or type shown.
100: A receptacle.
110: An opening in the receptacle 100 for insertion of items.
120: An optional chamber to hold items prior to passing them to the body of the receptacle 100.
130: A display, such as E-Paper, LCD, LED, Plasma, or other display technology including audio feedback such as a speaker system.
140: A network connection, such as a Wi-Fi or wired internet connection.
150: A network, such as the internet, another wide area network, or a local area network.
160: A server.
170. A tablet computing device or similar device.
180. A smart phone, computing goggles, portable computer, or similar device.
190. A laptop computer or similar device.
200. A desktop computer or similar device.
210. A camera, a microphone, a laser-scanner, a barcode reader, or similar device.
220. A local signal communications device, such as RFID, near field computing, Bluetooth, or similar device.
230. A scale.
240. An input device such as a stylus, keyboard, voice to data converter or other device used by a person to provide data to a computer.
250. A computing device.
260. A printer or similar device.
270. A device capable of reading and/or writing data to magnetic cards, RFID cards, or similar device.

FIG. 2 is a block diagram showing an example of a networked system for processing data and providing and other elements that may be used with or to perform one or more methods described herein.

FIG. 3 is a flow chart showing an example of a method that may be performed using the device and system shown in FIG. 1 or 2, or similar systems and devices.

### DETAILED DESCRIPTION

It is desirable, therefore, to provide a method, system and apparatus for improving to the rate of recycling and other environmentally beneficial acts. Among other things, these improvements solve a primary problem for the industry, improving rates of recycling and participation in other acts, such as environmentally beneficial acts.

The headings set forth below are merely to aid organization and readability of the disclosure, and do not limit the disclosed examples or concepts.

Processes performed by the machines, or system nodes described herein, or portions thereof, may be coded as machine readable instructions for performance by one or more programmable computers, and recorded on a computer-readable media. The described systems and processes merely exemplify various embodiments of enhanced features for use in the matter taught herein.

The examples given herein are all for the sake of illustration and shall not be considered limiting.

In teaching the matter described herein, we start with a discussion of the attached figures. FIG. 1 shows an exemplary implementation of one or more aspects of the systems, methods and apparatuses described herein. A receptacle 100 is provided for placement of items for recycling. The receptacle 100 has an opening 110 capable of receiving items. In some instances, it may be desirable to reduce the rates of placement of improper items in the receptacle 100. Recycling systems that attempt to limit deposit of erroneous items using limitations in the shape or capacity of the opening to the recycling bin are prone to failure. The causes for such failure include such problems as similar sizing of dissimilar items (i.e. a flattened can may be placed through an opening sized for a newspaper, used napkins may be placed through an opening sized for cans, glass bottles and aluminum cans both fit the same sized openings, etc.) and deposit of improperly prepared items (for example, placement of a full aluminum can into a recycling bin).

In one aspect, analysis of the item or items being offered for recycling is done. With regard to the analysis of an item, in one aspect, a scanner, camera, or other optical device 210 is used to analyze, or refine analysis of, the item. Note that while the optical device 210 is depicted in FIG. 1 as a single camera mounted on top of the receptacle 100, there may be more than one device, one or more of the devices may be capable of receiving audio data, and there may be a system of mirrors, a powered mechanical system for rotating an item or the device, or an unpowered mechanical system for rotating the item or the device. In one aspect, a code imprinted on the item is read by the optical device 210. For example, a bar code, QR code, alphanumeric code, plain text, or a combination thereof may be read. In some implementations, the object may be rotated, and/or mirrors utilized, to allow the optical device 210 to read sufficient markings to identify the item to within a set level of certainty (which level of certainty can vary greatly as to level and as to subject matter—for example, 50% likely to be a Pepsi® product, but 90% likely to be an aluminum can may or may not qualify depending on the criteria utilized).

In another aspect, objects may bear text that reveals sufficient data to identify or likely identify the original (or a subsequent) recipient of the item. For example, a magazine being placed in the receptacle 100 may have a mailing label that can be used to identify the recipient. Similarly, a cardboard box may have a similar label.

Reuse of some items without recycling may be desirable. For example, a person may read a magazine and place it in the receptacle 100. The optical device 210 may identify the magazine, the date of the material, or other characteristics of the material that may be used, alone or in combination with other data, to determine the value or desirability of the material for purposes other than recycling. The device may be programmed with instructions to segregate or otherwise treat such materials differently. In one aspect, materials with likely value to people with potentially recyclable materials may be offered as a reward for placement of such materials in the receptacle 100. To illustrate, if Jane places the current edition of Time Magazine in the receptacle 100, it may be determined that the magazine would be a desirable item and/or worth more without being recycled. In such a case, the magazine may be held in a separate compartment, displayed in some manner, or otherwise segregated or made available for retrieval. When Joe talks by with materials to recycle, if the materials meet set criteria, Joe may be offered the magazine upon deposit of such materials. In one aspect, credit for the recycling of Joe's materials may be given to Jane (whether or not Joe also gets credit for such materials, and Jane may also get credit—or be deprived credit—for the recycling of the magazine). If the magazine is ultimately not claimed before it no longer meets the criteria for not being recycled, the magazine may be moved to the recycle area and Jane may be given credit (if not already credited, or if desirable additional credit if already credited) for the magazine's recycling.

Where items are considered valuable in their non-recycled form (such as the magazine), in one implementation such items may be collected and distributed in various manners and to various recipients. In one aspect, books and/or magazines may be offered (manually or via an automated networked communication) to libraries and/or schools.

Where the optical device 210 contains or is an audio sensor, audio data may be utilized, among other things, to determine the suitability of an item for recycling (such as by analyzing the sound made by an item when placed in the receptacle 100 or staging area 120, differentiating, for example, a full can from an empty can). Such audio data may also be utilized as a user-generated input, for example using audio word recognition. Such data may be used for data input and/or data correction. With regard to data correction, a user may be asked (via speaker or display) for clarification, such as “I detected four aluminum cans, is that correct?”.

Similarly, the size and shape of the object may be analyzed. In one aspect, the optical device 210 may include a device capable of 3D imaging, such as a light field camera (technology similar to that utilized in devices sold by Lytro®), a system such as that used in the Xbox Kinect®, or some other 3D imaging system.

In one aspect, a weight scale 230 may be utilized to identify and/or refine the identification of an object. Such scale 230 may optionally be used in conjunction with volume measurements. Note that while FIG. 1 displays the scale as located on the bottom of the receptacle 100, such placement is merely exemplary. There may be more than one scale, and it may be placed under the staging area 120 or in such other location as may be useful. Furthermore, a scale 230 may be utilized in conjunction with other data to decrease the rate of erroneous placement of items within the receptacle 100. For example, if the optical device 210 determined that the user had placed a 16 ounce plastic bottle in the staging area 120, but the weight of the object was a pound, this is an indication that the bottle is still full of liquid. In such a case, the user may be notified, using a display 130, a speaker, a light, a combination thereof, or other means, that the object is rejected for recycling. The reason for such rejection may also be communicated. In one aspect, when an object is rejected for recycling, access to the primary compartment of the receptacle 100 may be blocked until the item is cleared from the staging area. In another aspect, the staging area may be equipped with means to eject such an item, such as an arm or a tilting mechanism. One aspect of such ejection mechanism may include ejection into a trash can or trash compartment.

Analysis of the item may be done, or refined, by analyzing signals sent by the item utilizing a receiver for such signals. Such antenna 220 may read Radio Frequency Identification (RFID) signals, Near Field Computing (NFC) signals, or other signals.

Additionally, the user may provide data as to the item directly via an input device 240, such as a keyboard, voice recognition system, tablet, or other input system.

In one aspect, for reasons of cost reduction or otherwise, it may be desirable to utilize technology in possession of the user in identifying the item or items being recycled. A non-limiting example may be a school district that desires to improve recycling rates but cannot afford to equip all classrooms with recycling bins equipped with optical devices 210 or other similar equipment. In such a case, the function of some or all of the elements shown in FIG. 1 as affixed to (or associated with) the receptacle 100 may be replaced with data obtained and/or received by a device operated by the end user. In this example, a teacher may place a tablet computer 170 near the recycling bin and/or students may utilize Android, iOS, or other portable devices 180 in conjunction with the receptacle 100.

In one aspect, a code may be placed on or near the receptacle 100 and/or displayed on a display 130 associated with the receptacle 100. The code may be a computer-readable code, a rotating code, a fixed code, a unique code, a temporary code placed by the end user, a code intended for manual entry by a user, or a combination thereof. Returning to the example, a student desiring to recycle three cans might place those cans on the staging area 120 of the receptacle 100 in such a manner that the code is visible (for example, if the code is printed on the top of the staging area) and/or in such a manner that the codes on the recycled items (i.e. bar codes on the cans) are visible. The student may then utilize the tablet computer 170 or other portable device 180 to take a photograph or video of the items, which photograph or video may include the receptacle's 100 code or some other identifying code as described above. In an aspect, the recyclable items may be positioned in a manner that makes their recovery difficult or impossible so as to prevent users from taking a photograph or video and then removing the items without actually recycling them. In one aspect, the staging area 120 may have a closing or locking mechanism, optionally in combination with a transparent surface such as a transparent cover.

The data from the photograph or video, or from the other data sources described herein, may then be sent to a computing device via a network 150 for further processing, may be processed within the device originating them (i.e. a tablet 170, a portable device 180, etc), may be processed in a computing device 250 within or attached to the receptacle 100, and/or may be directly transmitted via networked or non-networked protocol to a antenna (220 or 140) associated with the receptacle 100. In one implementation, a signing protocol may be utilized by the portable device 180 or tablet computer 170 to validate the identity of the sender and/or the location of the device and/or the contents of the codes images, and/or other data. Such signing protocol may be selected from various standard methods of data signing and/or encryption.

The optical device 210, scale 230, antenna 220, input device 240 or user device data may be used in conjunction with a staging area 120 or in an implementation that does not include a staging area 120.

A staging area 120 and/or an opening 110 for insertion of potential recyclable material may optionally be coupled with a sorting device and a plurality of compartments or containers. Items deposited for recycling may be analyzed utilizing the methods described above and diverted into an appropriate compartment or receptacle 100 based on such analysis. For example, where there is a simple rule that all paper materials must be separate from all other materials, but that all non-paper materials may be recycled together, the sorting device may separate paper and non-paper materials into separate compartments.

Because the contents of the receptacle 100 may already be inventoried utilizing the analysis mechanisms described herein, such inventory may be utilized to determine when to empty the receptacle 100 or other actions. Such inventory may also be utilized to determine the most efficient or cost effective mechanisms for disposition of the contents of the receptacle 100. For example, if the receptacle 100 contains 250 aluminum cans, the redemption value of the cans may be such that it would be worth having a team tasked with recouping redemption value pick up the contents. In one aspect, the inventory data may be made available individually or in aggregate form (for example, the extent recycling contents in a whole office building), on the internet or otherwise, for competitive bidding, which bidding may be cost of disposal or amount they are willing to pay to purchase the materials.

Turning again to the passage of potential recyclable materials through the device in FIG. 1, once the material or materials are identified, in the event that there is a staging area 120, the materials are released from the staging area 120 into the main body of the receptacle 100. As discussed above, materials may be sorted prior into compartments based on their nature.

After the materials have been accepted for recycling, the data generated in that process may be utilized to provide rewards, reinforcement, incentives, refunds, or other responses.

In one aspect, recyclable materials may be imprinted with a code that identifies the end user doing the recycling, the company doing the recycling, the place of origin of the item, and/or other data. Such codes may be imprinted at the time of manufacture, but may also be imprinted at other times, such as during the recycling process. To reduce the amount of resources needed to imprint the codes, in one implementation, the codes may be imprinted by puncturing, embossing or indenting the material. In such an implementation, for example, an aluminum can may be imprinted with a pattern of punctures that may later be read by a computer. In another implementation, the code may be affixed by scraping off or scratching the material. Stickers, inked stamps, and other modes of imprinting or affixing a code may also be utilized. The code may also be applied to one of a plurality of items, and set out the number of items to be covered by such code.

Where the person or entity desiring to recycle an item wishes to obtain some portion of the value of the recycled item (which may include a redemption or refund of a deposit, such as that under the “California Redemption Value” or similar programs), the person or entity may imprint a code on the item (or associate themselves with a code already imprinted on the item by updating a database). The code may optionally include data about what percentage or what raw amount of money the person or entity associated with the code claims. The code may optionally include data about the person or entity receiving the recyclable object from the person or entity imprinting the object. At the point of conversion of the item into funds, such as at a redemption center or at a recycling center, or at the point where the item is transferred to an entity designated as paying out based on the collection of the item and/or to which authority to receive funds is delegated, the value of the item is calculated or identified, the relative shares of the one or more persons or entities indicated as receiving a percentage or flat amount of the value is identified, and the proceeds are divided accordingly. In one aspect, a database is utilized wherein such data is stored. In another aspect, funds may be automatically divided and/or distributed utilizing a computerized process. Affiliate programs (such as grocery store loyalty programs) may be utilized to identify the purchaser of items. When items are pre-marked with a code, the purchaser may be identified at the point of purchase and such information stored in a database (or encoded on the items). In one implementation, the purchaser may need to actuate the codes after consuming the item and/or prior to handing the item over for recycling.

Illustrating this using a non-limiting example, in one of many possible implementations, Jane purchases 48 cans of soda. The cans are marked at the factory with unique codes. Jane enters her phone number at the cash register, her identity is pulled from a database, and when the cans are scanned at the register, her account is automatically linked to the unique codes on the cans. Joe, who runs a business going from house to house and collecting recyclable material, arranges to pick up the cans from Jane. When Joe brings the cans to the redemption center to obtain a refund of the redemption value and/or to obtain money for the value of the metal in the cans, the code is read and the proceeds are automatically split between Joe and Jane. In an alternate or additional implementation, non-financial credit (for example, credit on a social networking site) for the recycling may be granted to Joe, Jane, or a combination of the two.

In one implementation, companies may engage in recycling programs whereby the volume of their recycling is tracked utilized one or more of the methods described herein (i.e. codes, scanning, etc). The reduction in pollution (or other impacts) that result from the recycling is then credited, in one modality via a system utilizing networked communications, to that company. Such credit may be utilized as part of a larger offset/pollution market program whereby the company is able to offset a certain amount of pollution by claiming the amount of pollution avoided as a result of its recycling. In one implementation, such credit is tied to industry averages, company history, or other factors such that credit is given in a non-linear manner and/or for activities that meet certain criteria and/or exceed certain cut-offs. In one aspect, such credit may be utilized in programs such as a carbon dioxide emission credits marketplace.

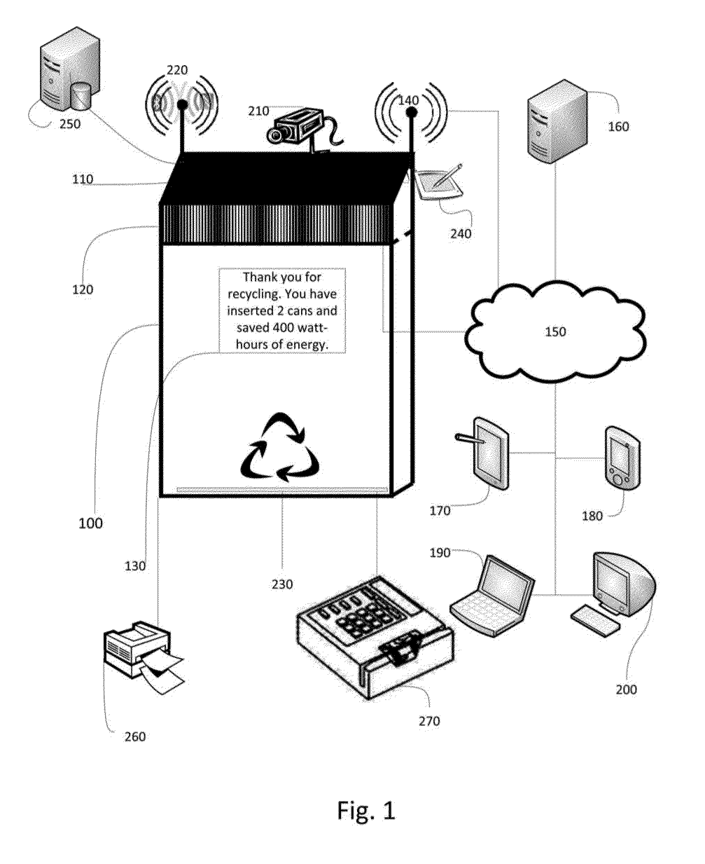

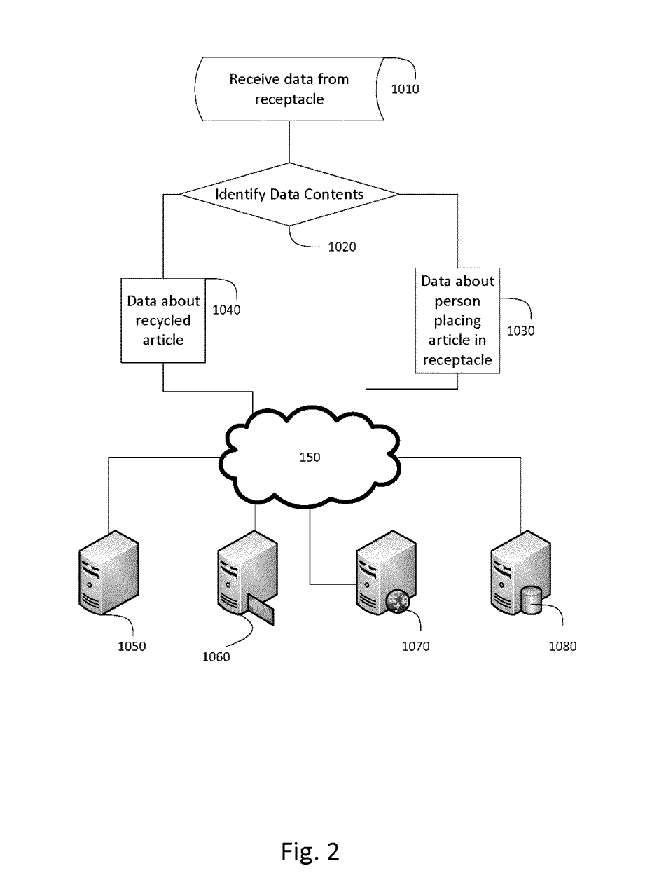

Turning to FIG. 2, the data from the receptacle 100 is received within a computer system at point 1010. The content of the data is identified 1020. The data may include data about the recycled article 1040 and/or data about the person or entity placing the article 1030 in the receptacle 100. Such data is sent via a network connection to one or more servers, such as a computer for processing data 1050, an e-commerce server 1060, a web server 1070, a database server 1080, or another type of computer or server.

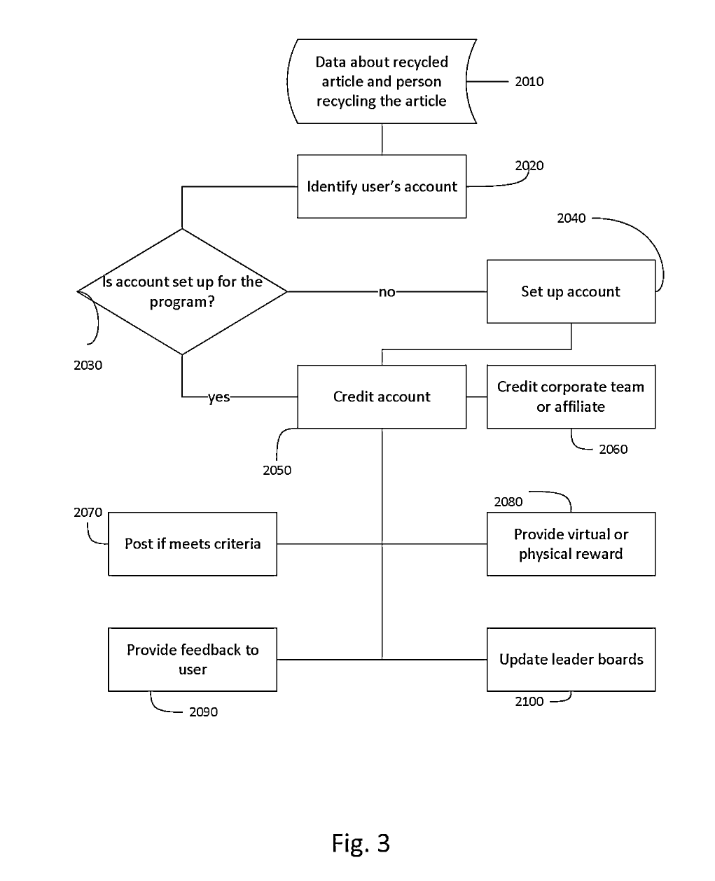

Data sent to the servers may be utilized in the manner shown in FIG. 3. The data 2010 is utilized to identify a user's account 2020 (which user may be an individual or an entity, depending on the application). Once the account is identified (or the lack of an account is identified), it is determined whether the user has an account set up to work with the aspects, functions or features described herein 2030. If the user does not have an account set up to work with the aspects, functions or features described herein, such an account is created (if it does not exist) and/or configured 2040. The account is then credited with the activity (which may be recycling of N number of X item) 2050. Where an individual is part of a recycling team, a corporate team, an affinity group, or some other group or entity that is to share or obtain credit in some manner for the activity, such credit may be recorded in an appropriate additional (or, in the case of multiple persons or entities sharing, more than one additional) account 2060.

One or more actions may take place at this point. In one aspect, a post (such as a Tweet or a Facebook® post) may be made, which may optionally be conditioned on user approval and/or meeting other criteria 2070. In one aspect, achievements are noted that are in quantifiable terms easily identifiable by humans. In a further aspect, such achievements are posted at set numbers. For example, recycling activity overall may be reported in tons of carbon dioxide saved, and posts made every 1,000 pounds; can recycling may be reported in kilowatt hours of energy saved, and posts made every time the user saves the average electrical use of a family for one week; newspaper recycling may be reported in pounds of paper and a post made every time a user has saved a full tree worth of paper. In one aspect, the user may set criteria for posting. In addition, or alternatively, the data may be presented in a constant manner, such as in a graphic that loads with their Facebook® news feed.

Another element may be virtual or physical rewards for recycling activity 2080. In one application, users of a game and/or virtual environment, such as a 3D virtual world, Zynga's Farmville, or other environment, may be credited with in-game goods, services and/or status based in whole or part on recycling activities. Such activities may be aggregated with those of other players or groups of players. In one aspect, elements saved in the physical world may be given to players in some related form (either related in quantity, quality, type, or a combination). For example, a player who saves 100 pounds of metal by recycling cans may be given 10% of that savings in the form of steel for forging swords in World of Warcraft®. Similarly, a player who saves 5% of a tree by recycling paper may earn a tree in Farmville. Energy savings, pollution avoided, and other measures may be associated with virtual goods or services. Such rewards may be calculated formulaically, may be stored in a database, may be identified on the items themselves; may be identified programmatically, or a combination thereof. A random or chance factor may be utilized to identify the rewards, to modify the rewards, or to otherwise impact or alter the rewards and/or the timing of the rewards. In one aspect, a virtual recycling program may be implemented, where recycling activities in the physical world are rewarded in a virtual environment. Recycling of items in the physical world may result in crediting of the same items in their original form in a virtual world, in a modified form, in their recyclable form, as the corresponding raw materials and/or energy savings, and/or in a form that corresponds to what the materials (or, in an aspect, similar materials) may be repurposed into after recycling. Similarly, energy savings or savings of other resources may be reflected in a virtual environment.

In one aspect, the amount and/or type of material being recycled may be determined by a method other than those described herein, such as by a manual review of such materials. Similarly, the amount and/or type of energy savings or other resource savings or usage may be determined. Once determined, such data may be entered into a computer system and calculations as to rewards based in whole or in part on such data. Where such data is generated by an automated process (such as energy metering) such data may be transmitted automatically. In one aspect, the rewards may be altered based on the data source. For example, self-reported data may be deemed unreliable and thus given a reduced or altered reward amount and/or type and/or capped at a certain reward amount.

In one aspect, companies and/or entities may be ranked in real time or near-real time for their recycling activities. Such data may be made available via networked devices or otherwise for use by consumers, companies, or other entities in making decisions as to how and whether to interact with the company or entity or its products.

In one implementation, the financial or otherwise financially tangible rewards of recycling (such as the reimbursement of a can deposit) may be wholly or partially decoupled from the virtual rewards. In one example, cans purchased by Jill that are ultimately recycled by Joe may result in the payment of all or part of the financial reward to Joe, but the credit of virtual rewards to Jill (whether tracked via the coding or other mechanisms described herein or otherwise). Taking this example further, Jill may earn one hour of membership to a game site for every can she purchased that is recycled (optionally up to a limit) regardless of whether she is the one who actually takes the can in for recycling. Virtual currency, such as the Second Life Lindon or the Utherverse® Ray™ may be utilized in whole or part as compensation for recycling or other activities.

In one aspect, feedback may be provided to the user based on the user's activities 2090. For example, the user may be able to check a web page and see that user's recycling activities to date, for certain periods, or using other criteria. The activities may also be translated to measurements more easily visualized or understood, such as trees saved.

In one aspect, users and/or groups of users may compete with each other and/or encourage each other through the use of leader boards 2100 or similar elements accessible by a plurality of people or entities. Rewards and/or status may be granted or earned based on leader board status.

Returning to FIG. 1, after processing data via a server 160 or other computerized mechanism, and/or after obtaining such data and transmitting it via a network 150, which network may be accessed via wifi antenna 140 or other mechanism, leader boards, virtual rewards, social network postings, and other feedback or interactive data may be displayed on a variety of devices, including tablets 170, portable devices 180, laptops 190, desktops 200, or other display devices. Furthermore, raw data about the recycling activity and/or processed data such as leader boards, virtual rewards, social network postings and other feedback or interactive data may be displayed at or near the receptacle 100 via the use of an attached display 130 and/or transmission via local network, WAN, internet, Bluetooth, wifi, NFC, or other mechanism to other nearby devices including tablets 170, portable devices 180, laptops 190, desktops 200, or other display devices.

Where there is no network connection or for other reasons it is desired to record recycling data in another manner, data may be printed via a printer 260 attached to or otherwise associated with or near the receptacle 100. Alternatively or additionally, data may be recorded via a card writer 270 to a magnetic card, a Universal Serial Bus (USB) stick, a memory card, or other device or card capable of holding data.

In one aspect, credit for recycling items may be recorded on paper (or on a memory card, magnetic card or other data device) in a manner that is analogous to a “bearer instrument”. This may credit be encoded, such as by bar code or QR code, and may have an associated password, which password may be entered, among other ways, via an input device 240. The user may then exchange the bearer instruments with other users, aggregate them, or treat them generally in the manner the user desires. When the bearer decides to obtain credit for his or her account, the user scans the code, enters the codes printed on the document, inserts the card into a reader, or otherwise identifies the data to a computing system. In one aspect, the code is consumable; such that once it is used it is no longer valid for any additional use.

In one aspect, a reward may be given via a local device such as a printer 260, may be transmitted via displayed code, such as a QR code located on a local display 130, may be transmitted via a network to a computing device such as a portable phone 180, or may otherwise be given. Such reward may be conditioned on or tied to recycling of a specified type of material, brand, or product. For example, Pepsi® may hold a promotion wherein the user obtains a coupon via a printer 260 for a free Pepsi® 16 ounce bottle for every 20 Pepsi® products they recycle. In one implementation, by aggregating bearer instruments showing recycling, such recycling activity can be done anonymously and/or without connection to an account, all without requiring such activity to be done in a single session in order to earn the reward.

In another aspect, refillable or rechargeable items may be identified and the user given the opportunity to recharge or refill them. For example, Pepsi® may sponsor a program whereby a liter or larger size Pepsi® product may be identified and the user offered a discounted (or free) refill. Such product may be refilled via issuance of a coupon, via a mechanism attached to or associated with the receptacle 100, or otherwise. Optionally, material that has been refilled may be marked, or a unique code associated with the material recorded in a database, and limitations placed on additional refills.

What is claimed is:

1. A method comprising:
obtaining, using an optical scanning device, information about material placed in a receptacle;
identifying said material;
determining at least one environmental benefit of recycling said material;
communicating via a display device said benefit to the person placing said material in said receptacle.

2. The method of claim 1, where the optical scanning device is a camera attached to a portable computing device connected to the receptacle via a network connection.

3. The method of claim 1, where an account associated with said person is identified and credited with recycling of said material.

4. The method of claim 3, wherein a plurality of accounts that have been credited are ranked according to at least one criteria related to recycling activity and listed in rank order on a page transmitted over a network.

5. The method of claim 1, where an account associated with said person is identified and a post is made to a computerized communications system associated with said account.

6. The method of claim 1, wherein a reward is provided to said user when said material being recycled meets criteria set for said reward.

7. The method of claim 6, wherein a coupon good for said reward is printed by a printing device located on or near said receptacle.

8. The method of claim 6, wherein a code representing said coupon is transmitted over a network to a user.

9. An apparatus, comprising:
a receptacle capable of receiving at least one kind of recyclable material;
said receptacle coupled to a scanning device capable of reading a bar code printed on said at least one kind of recyclable material;
said scanning device coupled to a computing device;
said computing device having a memory holding instructions to calculate at least one likely benefit of recycling of said recyclable material;
said computing device coupled to a display device capable of displaying said likely benefit.

10. The apparatus of claim 9, wherein said scanning device is coupled to a computing device via a wide area network.

11. The apparatus of claim 9, wherein said computing device holds further instructions for identifying materials that meet criteria for issuance of a reward, and issuing a reward when such criteria are met.

12. The apparatus of claim 9, wherein said computing device holds further instructions for identifying an account associated with a person placing an item in said receptacle.

13. The apparatus of claim 12, wherein the memory holds further instructions for crediting an account of said person with the recycling of said recyclable material.

14. A method comprising:
obtaining, using an optical scanning device, information about material placed in a receptacle;
identifying said material;
identifying an account associated with the person placing said material in said receptacle;
determining a reward associated with recycling of said material;
applying said reward to said account.

15. The method of claim 14, wherein said account is identified utilizing data transmitted via a portable device.

16. The method of claim 14, wherein said reward takes the form of virtual goods or services.

17. The method of claim 16, wherein said goods or services are related in some manner to said material being recycled.

18. The method of claim 14, wherein said reward is calculated at least in part based on chance.

19. The method of claim 14, wherein said reward is given after a threshold amount of material has been placed in said receptacle for recycling.

20. The method of claim 14, wherein for purposes of determining the account associated with the person placing said material in said receptacle, said person is a conclusively presumed to be a particular person who is associated with the receptacle, where such association may be one or more of the characteristics of ownership of the receptacle, operation of the receptacle, maintenance of the receptacle, sponsorship of the receptacle, collection from the receptacle, or control over the location within which the receptacle is located.
